(19) United States
(12) Patent Application Publication
(10) Pub. No.: US 2025/0014431 A1
(43) Pub. Date: Jan. 9, 2025

(54) Method for game play of an arcade game machine where a user tries to stop an LED light on or at a specific location in time

(71) Applicant: Gary Balaban, Sayreville, NJ (US)

(72) Inventor: Gary Balaban, Sayreville, NJ (US)

(21) Appl. No.: 18/633,410

(22) Filed: Apr. 11, 2024

Related U.S. Application Data
(60) Provisional application No. 63/458,460, filed on Apr. 11, 2023.

(51) Int. Cl. G07F 17/32

(52) U.S. Cl. CPC G07F 17/3295; G07F 17/3209; G07F 17/3213

(57) ABSTRACT

The present invention teaches a new type of arcade game and game play, which is known as “PERFECT 10”. The present invention teaches a simple game play where a customer tries to stop an LED counter at exactly 10.000. When the player starts the game, the counter begins at 0.000 and begins to count upward. When the counter gets close to 10.000, the customer tries to use the STOP button to get the timers to stop exactly at 10.000.

### FEDERALLY SPONSORED RESEARCH

Not Applicable

### SEQUENCE LISTING OR PROGRAM

Not Applicable

### TECHNICAL FIELD OF THE INVENTION

The present invention relates generally to game machines. More specifically, the present invention relates to game play of an arcade game machine where a user tries to stop an LED light on or at a specific location in time.

### BACKGROUND OF THE INVENTION

Arcade gaming has a long history and heritage that encompasses a great many game types, models, and audiences. Designing a successful game, that will keep the attention of an ever changing society is incredibly difficult.

The present invention teaches an arcade game with simple, repeatable game play, that includes a task that will engage users and keep them amused for multiple game plays.

### SUMMARY OF THE INVENTION

The present invention teaches a new type of arcade game and game play, which is known as “PERFECT 10”. The present invention teaches a simple game play where a customer tries to stop an LED counter at exactly 10.000. When the player starts the game, the counter begins at 0.000 and begins to count upward. When the counter gets close to 10.000, the customer tries to use the STOP button to get the timers to stop exactly at 10.000.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the physical structure of the arcade machine for playing the game taught by the present invention.

FIG. 2 illustrates the game and prize field of the arcade machine for playing the game taught by the present invention.

FIG. 3 illustrates the prize hangers of the arcade machine for playing the game taught by the present invention.

FIG. 4 illustrates the physical front appearance of the arcade machine including the prize field, and game controller/input for playing the game taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention teaches a new type of arcade game 101 and game play, which is known as “PERFECT 10”. The present invention teaches a simple game play where a customer tries to stop an LED counter 102 at exactly 10.000. When the player starts the game, the counter 102 begins at 0.000 and begins to count upward. When the counter 102 gets close to 10.000, the customer tries to use the STOP button input 103 to get the counter 102 to stop exactly at 10.000.

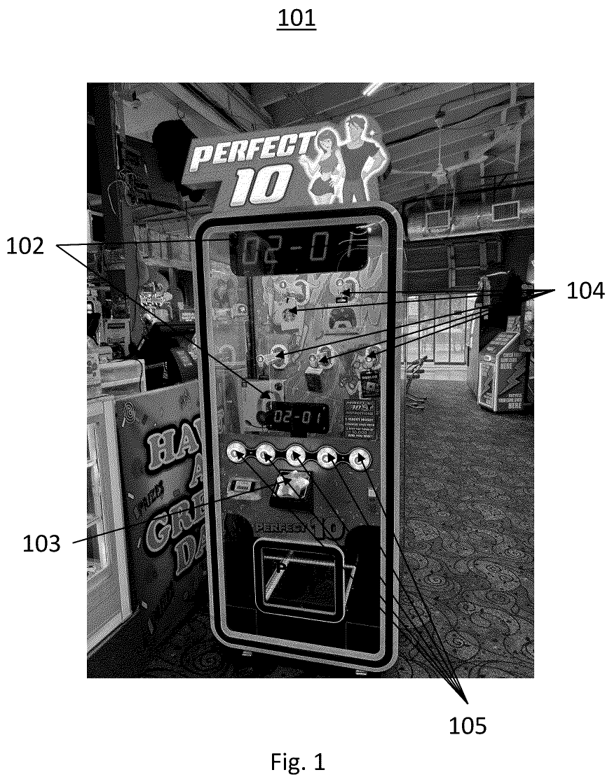

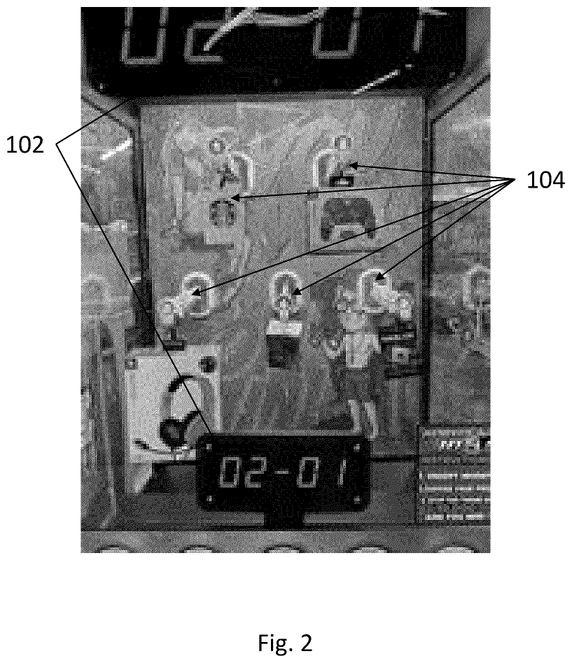

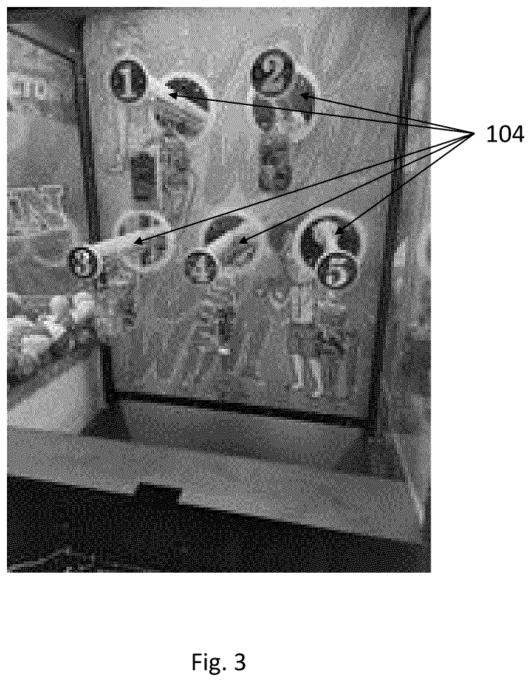

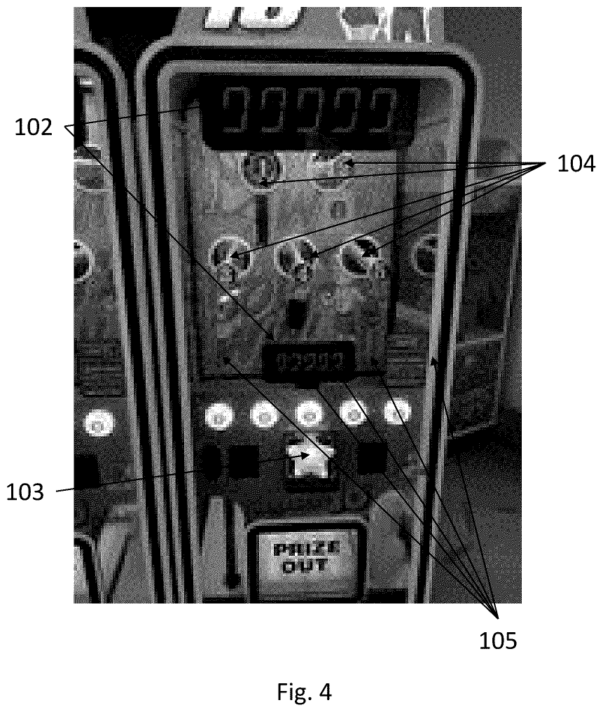

The gameplay method or process starts when a player chooses their prize. Inside the game cabinet 103, there is a plurality of number prizes 104, which corresponds to the numbered circular prize buttons 105. In FIG. 1-4, the exemplary embodiment illustrates a game cabinet with five potential numerically numbered prizes 104 corresponding to five numerically numbered prize buttons 105 on the outside of the game cabinet 103.

A user first selects the desired prize by pressing the corresponding numerically numbered prize button 105 matching the numerically numbered prize 104 inside the cabinet 103. Once the prize is selected, the counter 102 starts and the player then tries to stop the counter 102 exactly on 10.000 seconds.

In an alternative embodiment, once a player selects a prize button, the counter 102 displays a countdown from a predetermined amount of time, such as three seconds, before the counter 102 starts from zero and the player must attempt to stop it at 10.000 seconds.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. Method for game play of an arcade game machine where a user tries to stop an LED light on or at a specific location in time, comprising
a game machine with a cabinet displaying prizes on its interior and having player controls or inputs on its exterior and a counter;
presenting game play where a player tries to stop an LED counter at exactly a predetermined time;
when the player starts the game, the counter begins at 0.000 seconds and begins to count upward; and
when the counter gets close to the predetermined time, a player input is used to try and stop the counter exactly at the predetermined time.

2. The method of claim 1, wherein
the predetermined time is 10.000 seconds;
when the player starts the game, the counter begins at 0.000 seconds and begins to count upward; and
when the counter gets close to 10.000 seconds, a player input is used to try and stop the counter exactly at 10.000 seconds.

3. The method of claim 1, wherein
the gameplay starts when a player chooses their prize.

4. The method of claim 3, wherein
inside the game cabinet, there is a plurality of number prizes, which corresponds to numbered circular prize buttons on the outside of the game cabinet.

5. The method of claim 4, wherein
the game cabinet is provided with five potential numerically numbered prizes corresponding to five numerically numbered prize buttons on the outside of the game cabinet.

6. The method of claim 4, wherein
game play starts with first selecting the desired prize by pressing the corresponding numerically numbered prize button matching the desired numerically numbered prize inside the cabinet;
once the prize is selected, the counter starts and the player then tries to stop the counter exactly on at the predetermined time.

7. The method of claim 6, wherein the predetermined time is 10.000 seconds.

8. The method of claim 6, wherein
once a prize button is selected, the counter displays a countdown from a predetermined amount of time before the counter starts from zero and the player then tries to stop the counter exactly on at the predetermined time.

9. The method of claim 8, wherein
the counter displays a countdown from a predetermined amount of time, which is three seconds.

10. The method of claim 9, wherein the predetermined time is 10.000 seconds.
